(19) United States
(12) Patent Application Publication
(10) Pub. No.: US 2026/0260663 A1
(43) Pub. Date: Sep. 3, 2026

(54) MAGNETIC HEAD CLEANING DEVICE AND MAGNETIC TAPE DEVICE

(71) Applicant: NEC Platforms, Ltd., Kanagawa (JP)

(72) Inventor: Hidehiro URAHAMA, Kanagawa (JP)

(73) Assignee: NEC Platforms, Ltd., Kanagawa (JP)

(21) Appl. No.: 19/162,165

(22) PCT Filed: Mar. 6, 2024
(86) PCT No.: PCT/JP2024/008402

§ 371 Date: Sep. 4, 2025

(30) Foreign Application Priority Data
Mar. 17, 2023 (JP) 2023-042765

(51) Int. Cl. G11B 5/41

(52) U.S. Cl. CPC G11B 5/41

(57) ABSTRACT

The magnetic head cleaning mechanism of the present disclosure includes: a transmission gear connected to a driving source; a cam gear connected to mesh with the transmission gear; a cutting mechanism that cuts the power transmission of the cam gear and the transmission gear if a magnetic tape wound state is reached; a toothless gear connected to mesh with the transmission gear; a cleaning gear connected to mesh with the toothless gear; a deceleration mechanism that decelerates and transmits power from the transmission gear to the cleaning gear; a cleaning arm connected to the cleaning gear and having a cleaning member that cleans a magnetic head; and an intermittent transmission mechanism that cuts the power transmission of the toothless gear and the cleaning gear until the tape wound state is reached and that starts the transmission in a case where the tape wound state is reached.

### TECHNICAL FIELD

The present disclosure relates to a magnetic head cleaning mechanism and a magnetic tape device that clean a magnetic head in a tape wound state.

### BACKGROUND ART

The cleaning enabling device described in PTL 1 drives the cleaning arm via a protruding portion included in a cam gear, that is, a cam gear pressing portion. The cam gear is a gear that pulls a winding reel in the magnetic tape device. The cleaning enabling device described in PTL 1 further drives the cam gear from the tape wound state to drive the cleaning arm. The tape wound state is a state in which the magnetic tape is wound around a winding reel in the magnetic tape device.

### CITATION LIST

### Patent Literature

PTL 1: JP 2020-135905 A

### SUMMARY OF INVENTION

### Technical Problem

The cleaning enabling device described in PTL 1 is an accelerating mechanism because the reference circle diameter of the cam gear connected to the driving source is larger than the reference circle diameter of the latch gear to which the cam gear is connected. Furthermore, since the cleaning enabling device described in PTL 1 drives the cleaning arm in the tape wound state as described above, the cleaning arm needs to push away the magnetic tape stretched with a constant tension in the device to reach the magnetic head, and receives a reaction force from the magnetic tape at that time.

Therefore, in the cleaning enabling device described in PTL 1, since the reaction force received by the cleaning arm is transmitted to the cam gear in an amplified state via the accelerating mechanism of the cam gear, a load is applied to the driving source that drives the cam gear.

The present disclosure has been made to solve the above-described problems, and an object thereof is to provide a magnetic head cleaning mechanism and the like capable of reducing a load on a driving source.

### Solution to Problem

A magnetic head cleaning mechanism according to the present disclosure includes a transmission gear that is connected to a driving source, a cam gear that is connected so as to mesh with the transmission gear, a cutting mechanism that cuts power transmission of the cam gear and the transmission gear when a magnetic tape wound state is reached, a tooth-missing gear that is connected so as to mesh with the transmission gear, a cleaning gear that is connected so as to mesh with the tooth-missing gear, a decelerating mechanism that decelerates and transmits power from the transmission gear to the cleaning gear, a cleaning arm that is connected to the cleaning gear and includes a cleaning member that cleans a magnetic head, and an intermittent transmission mechanism that cuts power transmission of the tooth-missing gear and the cleaning gear until a tape wound state is reached and that starts the transmission in a case where the tape wound state is reached.

### Advantageous Effects of Invention

According to the present disclosure, it is possible to provide a magnetic head cleaning mechanism and the like capable of reducing a load on a driving source.

### BRIEF DESCRIPTION OF DRAWINGS

FIG. 1 is a plan view of a magnetic head cleaning mechanism 10 in the present example embodiment.

FIG. 2 is a detailed perspective view of a cam gear 101 in the present example embodiment.

FIG. 3 is a transmission view of a magnetic head cleaning mechanism 10 in the present example embodiment.

FIG. 4 is a diagram illustrating a state in which a magnetic tape traction arm 114 and a magnetic tape holding member 115 reach a magnetic tape winding reel 124.

FIG. 5 is a detailed perspective view of a portion provided with a cleaning member 731 in the present example embodiment.

FIG. 6 is a detailed perspective view of a transmission gear 201 in the present example embodiment.

FIG. 7 is a diagram illustrating a state immediately before starting magnetic tape traction.

FIG. 8 is a diagram illustrating a state in which the transmission gear 201 rotates counterclockwise about one and a half turns from the state of FIG. 7 and reaches a magnetic tape wound state.

FIG. 9 is a diagram illustrating a state in which the transmission gear 201 further rotates clockwise by about 45 degrees from the state of FIG. 8.

FIG. 10 illustrates a state in which the transmission gear 201 further rotates clockwise by about one turn from the state of FIG. 9 and the cleaning member 731 reaches a magnetic head cleaning position.

FIG. 11 is a detailed perspective view of a cam gear 801 in which a cam gear tooth tip sliding surface 103 is replaced with a roller 813.

FIG. 12 is a perspective view of a roller holding arm 811 and a roller 813.

### EXAMPLE EMBODIMENT

Hereinafter, example embodiments according to the present disclosure will be described in detail with reference to the drawings.

### Configuration

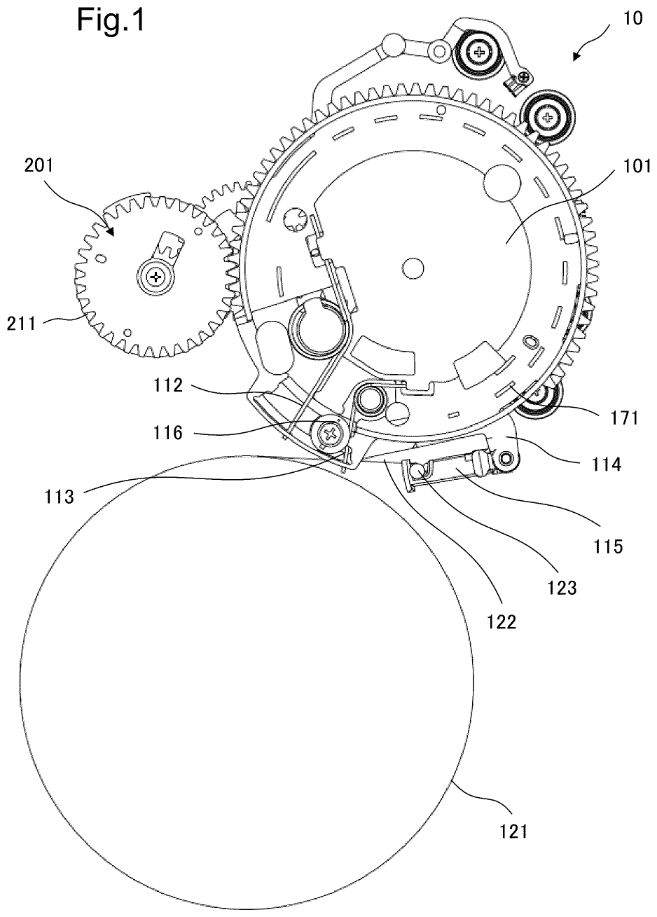

FIG. 1 is a plan view of a magnetic head cleaning mechanism 10 in the present example embodiment. The magnetic head cleaning mechanism 10 is a part of the configuration of a magnetic tape device 1. As illustrated in FIG. 1, the magnetic head cleaning mechanism 10 includes a cam gear 101, a transmission gear 201, and a cartridge reel 121.

The cam gear 101 is connected to the transmission gear 201. The cam gear 101 and the transmission gear 201 are pivotally supported on a base member (not illustrated) so as to engage with each other while maintaining an appropriate center distance. The cam gear 101 rotates in a direction opposite to the rotation direction of the transmission gear 201 along with the rotation of the transmission gear 201.

The transmission gear 201 is a gear in which the number of power transmission stages from the driving source is located at a preceding stage of the cam gear 101. As illustrated in FIG. 1, the reference circle diameter of the transmission gear 201 is smaller than the reference circle diameter of the cam gear 101. The transmission gear 201 is connected to a driving source (not illustrated) and rotates by the driving source.

The cartridge reel 121 is for winding and storing a magnetic tape 122. In FIG. 1, only the outer diameter portion of the cartridge reel 121 is illustrated. A leader pin 123 is provided at an end of the magnetic tape 122 stored in the cartridge reel 121.

The cam gear 101 includes a first torsion coil spring 112, a second torsion coil spring 113, and a magnetic tape traction arm 114.

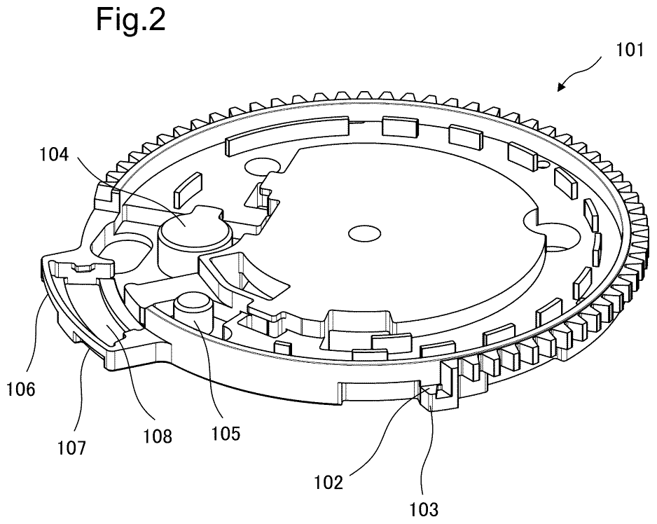

FIG. 2 is a detailed perspective view of the cam gear 101 in the present example embodiment. The first torsion coil spring 112 is wound clockwise around a first projection 104 provided on one side of the cam gear 101. The second torsion coil spring 113 is wound counterclockwise around a second projection 105 provided on one side of the cam gear 101. One end of an arm of the first torsion coil spring 112 protrudes so as to penetrate a first space 106 of the cam gear 101, and one end of an arm of the second torsion coil spring 113 protrudes so as to penetrate a second space 107. The first space 106 and the second space 107 are provided in the radial direction of the cam gear 101. A plurality of teeth are continuously formed on a flange-shaped circumferential outer surface on one side of the cam gear 101. The flange-shaped circumferential outer surface of the cam gear 101 also includes a region where no teeth are formed.

The magnetic tape traction arm 114 is overlapped and fixed so as to be in contact with the other surface side of the cam gear 101. The magnetic tape traction arm 114 includes an L-shaped arm portion and a linear arm portion, and one end of the L-shaped arm portion and one end of the linear arm portion are pivotally supported by a rotation shaft. A cylindrical portion 116 is provided at the other end of the L-shaped arm portion. A magnetic tape holding member 115 is provided at the other end of the linear arm portion.

The cylindrical portion 116 is held so as to be rotatably movable in the arc direction while being biased by the first torsion coil spring 112 and the second torsion coil spring 113 in a third space 108 provided along the arc-shaped protrusion formed on a part of the outer periphery of the cam gear 101.

The magnetic tape holding member 115 is configured to pull out the magnetic tape 122 from the cartridge reel 121. The magnetic tape holding member 115 enters a magnetic tape cartridge (not illustrated) mounted in the magnetic tape device, and holds the leader pin 123 provided at an end of the magnetic tape 122 wound and stored by the cartridge reel 121. When the cam gear 101 rotates counterclockwise in a state where the leader pin 123 is gripped by the magnetic tape holding member 115, the magnetic tape holding member 115 and the leader pin 123 move in the counterclockwise direction via the first torsion coil spring 112. As a result, the magnetic tape 122 is pulled out from the cartridge reel. The cartridge reel 121 is connected to a driving source (not illustrated) different from the cam gear 101 to control rotation. Therefore, the magnetic tape 122 is fed out while being constantly applied with a constant tension.

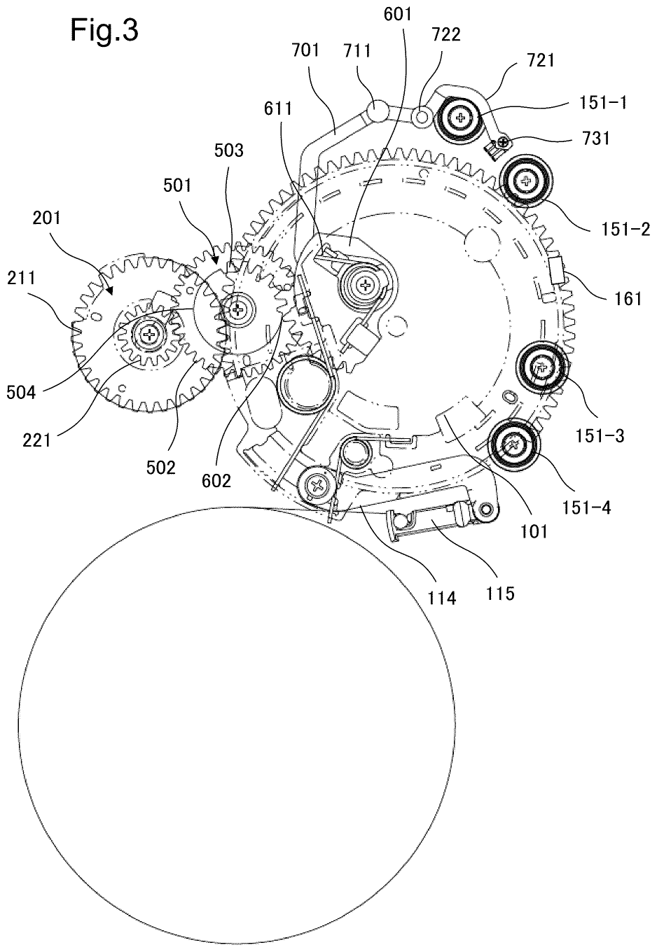

FIG. 3 is a diagram illustrating the cam gear 101 and the transmission gear 201 according to the present example embodiment in a transparent manner. As illustrated in FIG. 3, the magnetic tape device includes guide rollers 151-1, 151-2, 151-3, and 151-4 and a magnetic head 161. In FIG. 3 and the following drawings, only the installation position of the magnetic head 161 is illustrated. In the following description, the guide rollers 151-1 to 151-4 will be referred to as a guide roller group 151 when it is not particularly necessary to distinguish them. The guide roller group 151 is disposed on the other surface side of the cam gear 101.

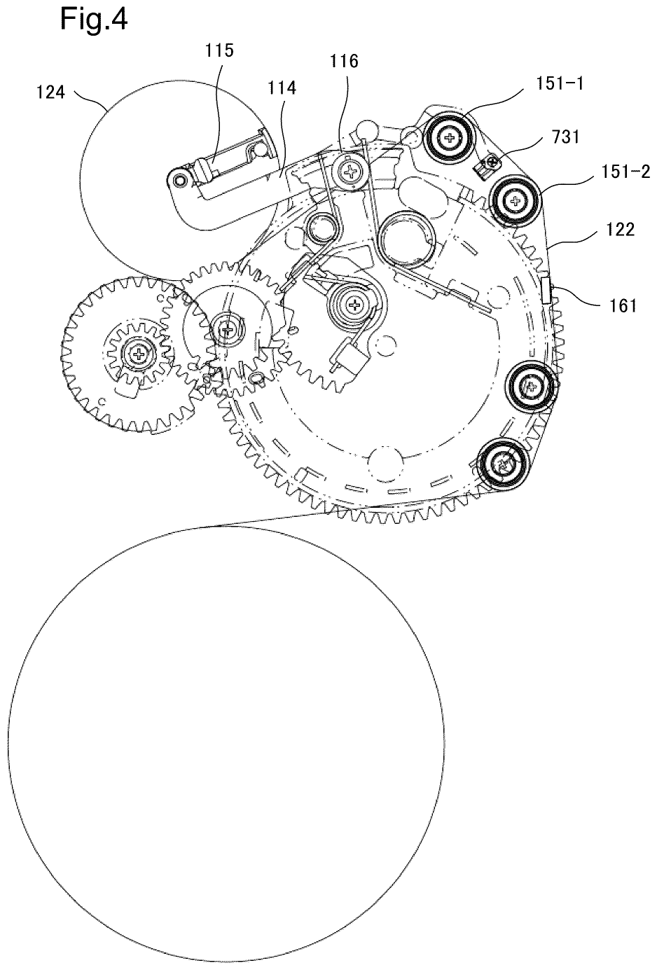

In the state of FIG. 3, when the transmission gear 201 rotates clockwise, the cam gear 101 rotates counterclockwise. When the cam gear 101 rotates counterclockwise, the magnetic tape traction arm 114 and the magnetic tape holding member 115 reach a magnetic tape winding reel 124 through the vicinity of the guide roller group 151 (guide rollers 151-1, 151-2, 151-3, and 151-4) and the magnetic head 161. FIG. 4 is a diagram illustrating a state in which the magnetic tape traction arm 114 and the magnetic tape holding member 115 reach the magnetic tape winding reel 124. As described above, a constant tension is applied to the magnetic tape 122. Therefore, with the movement of the magnetic tape traction arm 114 and the magnetic tape holding member 115, the magnetic tape 122 is guided inside the magnetic tape device so as to be in contact with the surfaces of the guide roller group 151 and the magnetic head 161.

When the magnetic tape holding member 115 and the leader pin 123 reach the magnetic tape winding reel 124, the magnetic tape holding member 115 and the leader pin 123 are stored in the frontage of the magnetic tape winding reel 124. As a result, the magnetic tape holding member 115, the leader pin 123, and the magnetic tape winding reel 124 rotate integrally. When the magnetic tape winding reel 124 is rotated by a driving source (not illustrated) in a state where the magnetic tape holding member 115 and the leader pin 123 are stored in the frontage of the magnetic tape winding reel 124, the magnetic tape 122 is wound into a tape wound state.

As illustrated in FIG. 3, the transmission gear 201 includes a two-stage gear pivotally supported by a common rotation shaft. A transmission large gear 211 is provided on one side of the transmission gear 201. One surface side of the transmission gear 201 is a surface side in the same direction as one surface side of the cam gear 101. The transmission large gear 211 is connected so as to mesh with the cam gear 101 while maintaining an appropriate center distance. On the other surface side of the transmission gear 201, a transmission small gear 221 is provided at a position away from the transmission large gear 211. The transmission small gear 221 is connected so as to mesh with a tooth-missing large gear 502 provided on one side of a tooth-missing gear 501 while maintaining an appropriate center distance. The reference circle diameter of the transmission small gear 221 is smaller than the reference circle diameter of the tooth-missing large gear 502.

The tooth-missing gear 501 includes a two-stage gear pivotally supported by a common rotation shaft. The tooth-missing gear 501 includes a tooth-missing small gear 503 on one side. One surface side of the tooth-missing gear 501 is a surface side in the same direction as one surface side of the cam gear 101, but the tooth-missing gear 501 is disposed on the other surface side of the cam gear 101. Therefore, only a part of the tooth-missing gear 501 is visible in the plan view illustrated in FIG. 1. The tooth-missing small gear 503 is connected so as to mesh with a cleaning gear 601 at an appropriate center distance. The reference circle diameter of the tooth-missing small gear 503 is smaller than the reference circle diameter of the cleaning gear 601. The tooth-missing small gear 503 is partially missing teeth. A tooth-missing gear cylindrical surface 504 is provided in the toothless portion of the tooth-missing small gear 503. The tooth-missing large gear 502 is provided on the other surface side of the tooth-missing gear 501. As described above, the tooth-missing large gear 502 is connected so as to mesh with the transmission small gear 221 while maintaining an appropriate center distance.

The cleaning gear 601 is a gear connected to a cleaning large arm 701. As previously described, the cleaning gear 601 is connected so as to mesh with the tooth-missing small gear 503 while maintaining an appropriate center distance. The cleaning gear 601 is partially provided with teeth. The rotation of a cleaning gear starting tooth 602 of the cleaning gear 601 in the clockwise direction is limited by the tooth-missing gear cylindrical surface 504. The diameter of the tooth-missing gear cylindrical surface 504 is set such that the cleaning gear starting tooth 602 is held at a position where the cleaning gear starting tooth 602 can appropriately start meshing with the cleaning gear starting tooth when the tooth-missing small gear 503 rotates counterclockwise.

The cleaning large arm 701 is pivotally supported so as to be rotatably driven coaxially with the cleaning gear 601. The cleaning large arm 701 is rotatably connected to a cleaning small arm 721 via a coupling portion 711. The cleaning small arm 721 is provided with a guide pin 722. The cleaning small arm 721 is coupled to a guide groove provided in a guide member (not illustrated) by the guide pin 722. A holder 741 is provided at the tip of the cleaning small arm 721.

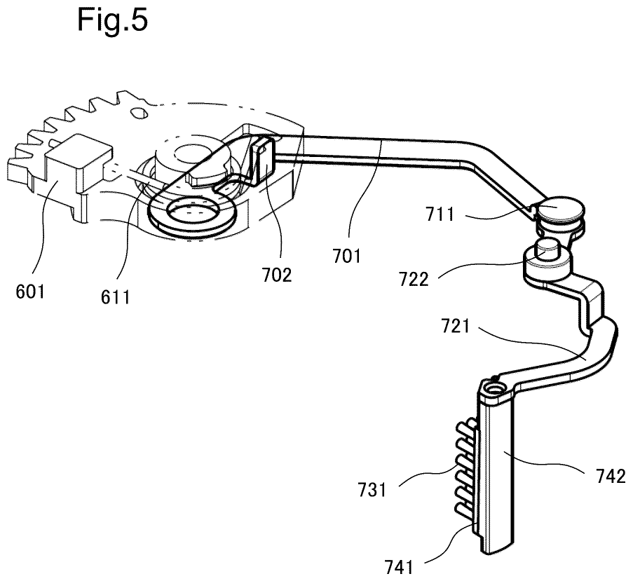

FIG. 5 illustrates a detailed perspective view of the installation portion of a cleaning member 731. The cleaning member 731 is provided to the cleaning small arm 721 via the holder 741. A smooth surface 742 is provided on the other surface side of the surface of the holder 741 holding the cleaning member 731. The cleaning member 731 is in contact with the magnetic head 161 and cleans the magnetic head. The smooth surface 742 comes into contact with the magnetic tape and pushes the magnetic tape away. The holder 741 is slidable by the smooth surface 742 without damaging the magnetic tape 122.

As illustrated in FIG. 4, the standby positions of the cleaning member 731 and the holder 741 are set, for example, between the guide roller 151-1 and the guide roller 151-2 with the magnetic tape 122 interposed therebetween. The standby position may be any position as long as it reaches the magnetic head cleaning position, and is not limited to the above position. The magnetic head cleaning position is set at a position where the magnetic head 161 and the cleaning member 731 face each other. The cleaning small arm 721, the cleaning member 731, the holder 741, and the cleaning member 731 pass through the guide groove, pass through an appropriate path in the magnetic tape, and move between the standby position and the magnetic head cleaning position. The appropriate path is a path in which the cleaning member 731 does not come into contact with the guide roller group 151 and the smooth surface 742 comes into contact with the magnetic tape 122. When the cleaning large arm 701 rotates clockwise in the magnetic tape wound state, the cleaning member 731 and the holder 741 are moved via the coupling portion 711 and the cleaning small arm 721. At that time, the cleaning member 731 and the holder 741 move while pushing the magnetic tape 122 away by the smooth surface 742.

The cleaning gear 601 and the cleaning large arm 701 are connected via an anti-lock spring 611. The cleaning gear 601 is biased so as to abut on an abutment portion 702 provided in the cleaning large arm 701 in the counterclockwise direction. Therefore, the cleaning gear 601 normally rotates integrally with the cleaning large arm, but when the cleaning gear 601 rotates clockwise, the guide pin 722 reaches the end of the guide groove, and the cleaning small arm 721 stops, the anti-lock spring 611 is elastically deformed, and only the cleaning gear 601 continues to rotate.

The description returns to FIG. 2. FIG. 2 is a detailed perspective view of the cam gear 101. As illustrated in FIG. 2, the cam gear 101 is partially provided with teeth in a range necessary for pulling the magnetic tape. As illustrated in FIG. 2, a cam gear terminal tooth 102 are provided below the other teeth in the axial direction. The lower side is an opposite surface side when one surface side of the cam gear 101 is an upper side, that is, the other surface side. A cam gear tooth tip sliding surface 103 is provided at the corner of the tooth tip of the cam gear terminal tooth 102 so as to smoothly connect the corner of the tooth tip. The cam gear tooth tip sliding surface 103 has surface roughness suitable as a sliding surface.

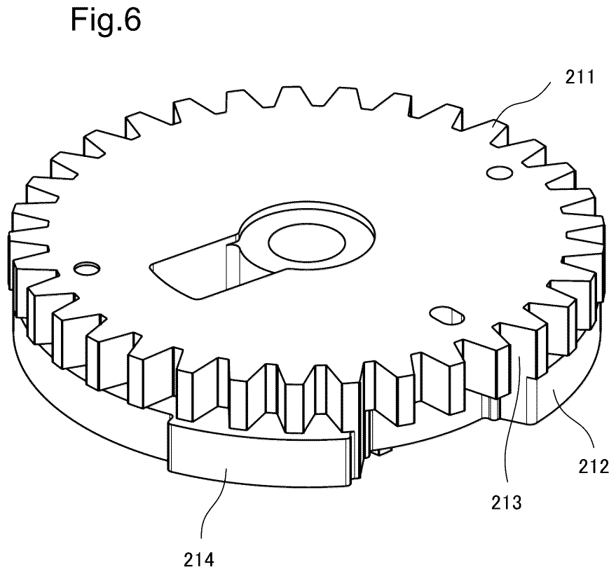

FIG. 6 is a detailed perspective view of the transmission large gear 211 provided on one side of the transmission gear 201. As illustrated in FIG. 6, a transmission gear cylindrical surface 212 is provided in a partial range of a lower portion of the transmission large gear 211 in the axial direction. The starting position of the transmission gear cylindrical surface 212 is smoothly connected to a transmission gear cylindrical surface starting tooth 213. The transmission gear cylindrical surface 212 has a surface roughness suitable as a sliding surface.

The number of teeth and meshing positions of the cam gear 101 and the transmission gear 201 are set such that the cam gear terminal tooth 102 and the transmission gear cylindrical surface starting tooth 213 are engaged with each other in the magnetic tape wound state. Therefore, when the transmission gear 201 continues to rotate clockwise in the magnetic tape wound state, the first torsion coil spring 112 of the cam gear 101 further continues to rotate while being elastically deformed, and rides up so as to come into contact with the transmission gear cylindrical surface 212 with the cam gear tooth tip sliding surface 103 provided at the corner of the tooth tip of the cam gear terminal tooth 102. Due to the repulsive force of the first torsion coil spring 112, the cam gear tooth tip sliding surface 103 slides while pressing the transmission gear cylindrical surface 212. That is, the cam gear 101 rotates with the rotation of the transmission gear 201 while the magnetic tape 122 is towed, but stops power transmission between the cam gear 101 and the transmission gear 201 in a range in which the transmission gear 201 further rotates than in the magnetic tape wound state. In other words, the cam gear terminal tooth 102, the cam gear tooth tip sliding surface 103, and the transmission gear cylindrical surface 212 function as a cutting mechanism that cuts power transmission of the cam gear 101 and the transmission gear 201 when the tape wound state is reached. That is, the cutting mechanism includes a transmission large gear provided on one side of the transmission gear and having a cylindrical surface in a partial range.

As described above, when the transmission gear 201 continues to rotate clockwise in the magnetic tape wound state, the cam gear 101 stops. On the other hand, the tooth-missing gear 501 continues to rotate counterclockwise by power transmission from the transmission small gear 221. In the tooth-missing gear 501, a generation range of teeth and a meshing position with the transmission gear 201 are set such that the teeth of the tooth-missing small gear 503 start meshing with the teeth of the cleaning gear 601 after the cam gear 101 is stopped. Therefore, the cleaning gear 601 is provided to start to rotate clockwise via the tooth-missing gear 501 when the transmission gear 201 further continues to rotate even after the cam gear 101 stops although the cleaning gear 601 is stopped until the magnetic tape is wound and the cam gear 101 stops. In other words, the cleaning gear 601 is provided to perform intermittent movement. Specifically, the tooth-missing small gear 503 and the tooth-missing gear cylindrical surface 504 function as an intermittent transmission mechanism that cuts the power transmission of the transmission gear 201 and the cleaning gear 601 until reaching the tape wound state and starts the transmission when reaching the tape wound state. That is, the intermittent transmission mechanism includes a tooth-missing small gear provided on one side of the tooth-missing gear and provided with a cylindrical surface in a partial range.

The number of teeth of each of the transmission gear 201, the tooth-missing gear 501, and the cleaning gear 601 is set in consideration of power transmission from the transmission gear 201 to the cleaning gear 601 after deceleration. Unlike the cam gear 101, although the cleaning gear 601 does not actively cause a pressing phenomenon to the tooth-missing gear 501 due to the spring, a sliding phenomenon may occur depending on the position of the part. Therefore, the tooth-missing gear cylindrical surface 504 and the tooth tip portion of the cleaning gear starting tooth 602 have surface roughness suitable as a sliding surface.

As illustrated in FIG. 6, a transmission gear protrusion 214 is provided at the end of the transmission gear cylindrical surface 212. The transmission gear protrusion 214 is provided at a position to be engaged with the cam gear terminal tooth 102 when the transmission gear 201 further continues to rotate clockwise after the cleaning gear 601 is driven by the transmission gear 201 and the cleaning member 731 reaches the magnetic head 161. When the transmission gear protrusion 214 and the cam gear terminal tooth 102 are engaged with each other, the cam gear terminal tooth 102 are pushed by the transmission gear protrusion 214, and the cam gear 101 rotates counterclockwise. In the present example embodiment, when a sensor flag 171 provided on the cam gear 101 is detected by a sensor (photointerrupter) (not illustrated) and it is detected that the cleaning member 731 reaches the magnetic head cleaning position, the rotation of the driving source is stopped. The sensor flag 171 is also provided at a position in the magnetic tape wound state so as to be able to detect the magnetic tape wound state and a state before the cleaning gear 601 is driven. As a result, the magnetic tape wound state and the cleaning arm driving completion state are detected, and the driving source can be controlled to transition the states in response to a user request.

### Operation

Next, an operation of the magnetic head cleaning mechanism 10 according to the present example embodiment will be described. The operation of the magnetic head cleaning mechanism 10 according to the present example embodiment is roughly divided into the following four steps. Each step will be described below.
1. Step of magnetic tape traction
2. Step of magnetic tape winding
3. Step of magnetic head cleaning
4. Step after completion of magnetic head cleaning

### 1. Magnetic Tape Traction Step

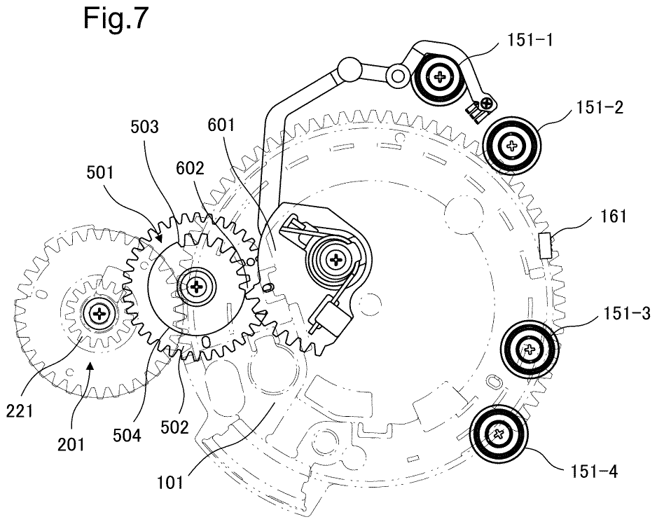

FIG. 7 is a diagram illustrating a state immediately before the start of magnetic tape traction. In FIG. 7, only members necessary for describing the operation are indicated by thick solid lines.

First, the transmission gear 201 rotates clockwise by a driving source (not illustrated). As a result, the cam gear 101 connected so as to mesh with the transmission gear 201 rotates counterclockwise. The magnetic tape traction arm 114 and the magnetic tape holding member 115 (not illustrated in FIG. 7) included in the cam gear 101 rotate with the rotation of the cam gear 101. The magnetic tape traction arm 114 and the magnetic tape holding member 115 reach the magnetic tape winding reel 124 (not illustrated in FIG. 7) through the vicinity of the guide roller group 151 and the magnetic head 161 (not illustrated in FIG. 7). The magnetic tape 122 is pulled to the magnetic tape winding reel 124 by this series of operations.

When the transmission gear 201 rotates clockwise, the transmission small gear 221 included in the transmission gear 201 also rotates clockwise. As a result, the tooth-missing large gear 502 connected so as to mesh with the transmission small gear 221 rotates counterclockwise. Along with the rotation of the tooth-missing large gear 502, the tooth-missing small gear 503 provided on the other surface side of the tooth-missing gear 501 also rotates counterclockwise.

The cleaning gear 601 connected with the tooth-missing small gear 503 remains stationary because the cleaning gear starting tooth 602 are restricted in rotation by the tooth-missing gear cylindrical surface 504.

### 2. Step of Magnetic Tape Winding

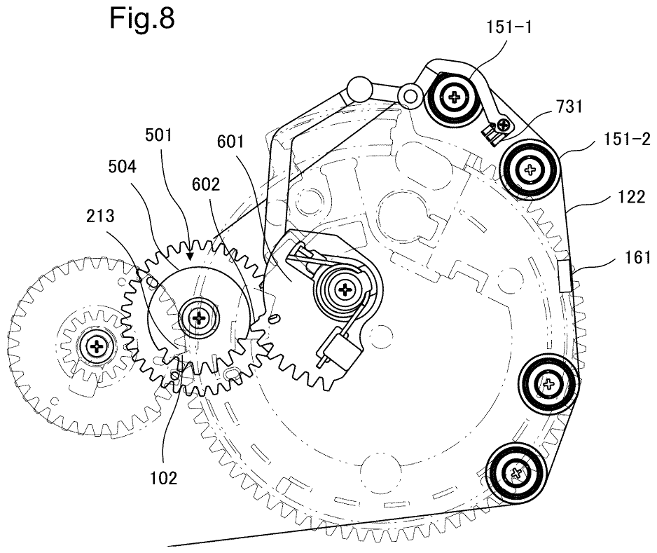

FIG. 8 is a diagram illustrating a state in which the transmission gear 201 rotates counterclockwise about one and a half turns from the state of FIG. 7 to reach the magnetic tape wound state. The cam gear terminal tooth 102 of the cam gear 101 meshes with the transmission gear cylindrical surface starting tooth 213 of the transmission gear.

As the transmission gear 201 rotates, the tooth-missing gear 501 also rotates counterclockwise about a half turn. Since the state in which the rotation of the cleaning gear 601 is restricted by the tooth-missing gear cylindrical surface 504 continues, a stopped state is maintained.

### 3. Step of Magnetic Head Cleaning

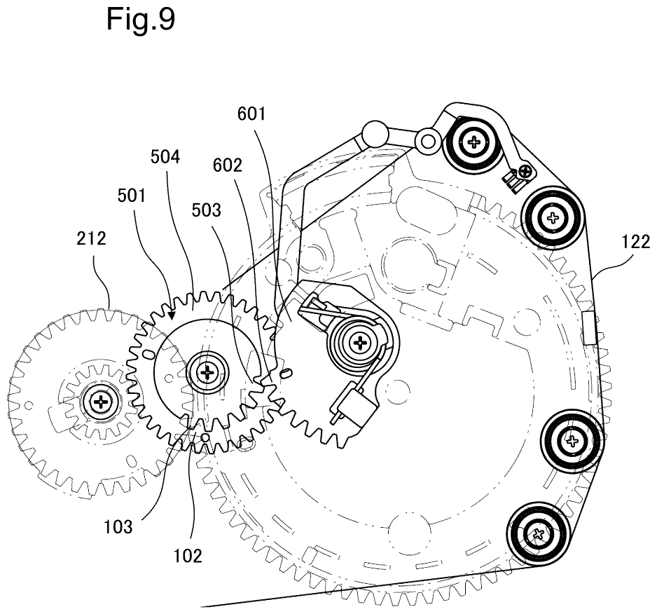

FIG. 9 is a diagram illustrating a state in which the transmission gear 201 further rotates clockwise by about 45 degrees from the state of FIG. 8. At this time, the cam gear terminal tooth 102 ride on the transmission gear cylindrical surface 212. As a result, power transmission from the transmission gear 201 to the cam gear 101 is interrupted, and the cam gear 101 maintains a stopped state.

In the state of FIG. 9, the tooth-missing small gear 503 has reached a position to start meshing with the cleaning gear starting tooth 602. When the transmission gear 201 rotates clockwise from this state, the cleaning gear 601 is driven.

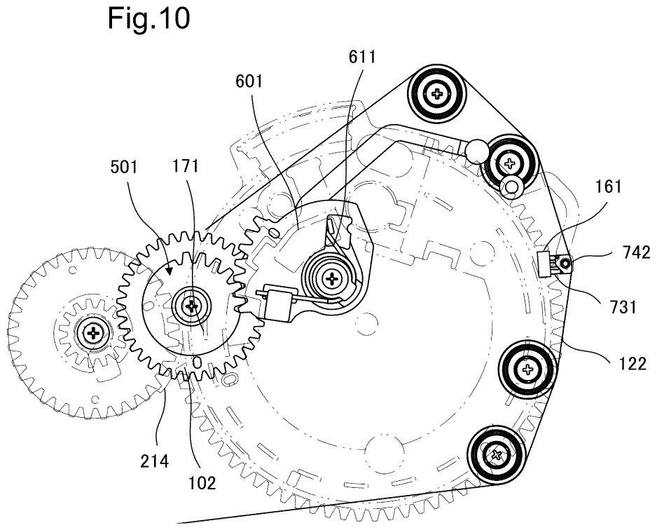

FIG. 10 illustrates a state in which the transmission gear 201 further rotates clockwise about one turn from the state of FIG. 9 and the cleaning member 731 reaches the magnetic head cleaning position. In the state of FIG. 10, the cleaning gear 601 is rotated by the tooth-missing gear 501 to a position where an anti-lock spring 611 is elastically deformed. As a result, the cleaning member 731 reaches the magnetic head cleaning position.

The magnetic tape 122 is pushed away in contact with the smooth surface 742. When reaching the magnetic head cleaning position, the magnetic tape 122 is held in a state as illustrated in FIG. 10.

As a result of the cam gear terminal tooth 102 being pushed by the transmission gear protrusion 214 and further rotated, the sensor detects that the magnetic head cleaning position has been reached. As a result, the driving source connected to the transmission gear stops.

### 4. Step after Completion of Magnetic Head Cleaning

When the magnetic head cleaning is completed, the transmission gear 201 reversely rotates counterclockwise from the state of FIG. 10. As a result, the magnetic head cleaning mechanism 10 returns to the magnetic tape wound state of FIG. 8. The sensor detects the return to the magnetic tape wound state.

### Effect

Next, effects of the magnetic head cleaning mechanism 10 in the present example embodiment will be described.

The magnetic head cleaning mechanism 10 in the present example embodiment drives a cleaning arm 710 in a state where power transmission between the transmission gear 201 and the cam gear 101 connected to the driving source is disconnected. The magnetic head cleaning mechanism 10 in the present example embodiment has an intermittent transmission mechanism that cuts power transmission of the tooth-missing gear 501 and the cleaning gear 601 until reaching the tape wound state and starts the transmission when reaching the tape wound state. As a result, the cleaning arm 710 can freely rotate while the cam gear 101 is stopped. That is, the drive range of the cleaning arm 710 is not limited to the drive range allowed for the cam gear 101 due to the device space. Therefore, unlike the cleaning enabling device disclosed in PTL 1, the magnetic head cleaning mechanism 10 in the present example embodiment does not need to include an accelerating mechanism. Furthermore, the magnetic head cleaning mechanism 10 in the present example embodiment decelerates to drive the cleaning arm 710. This is because the magnetic head cleaning mechanism 10 includes a decelerating mechanism that decelerates and transmits power from the transmission gear 201 to the cleaning gear 601. The cleaning gear 601 to which the cleaning arm 710 is connected is connected to the transmission gear 201 via the decelerating mechanism. Therefore, the reaction force received by the cleaning arm 710 is reduced via the decelerating mechanism and transmitted to the driving source. With this configuration, the magnetic head cleaning mechanism 10 in the present example embodiment can reduce the load applied to the driving source. Accordingly, the life of the driving source can be prolonged. The decelerating mechanism in the present example embodiment is achieved by adopting a gear train in which the reference circle diameter of the transmission small gear 221 is smaller than the reference circle diameter of the tooth-missing large gear 502 as a connection destination, and the reference circle diameter of the tooth-missing small gear 503 is smaller than the reference circle diameter of the cleaning gear 601 as a connection destination. The decelerating mechanism is not limited to this, and may be a power transmission mechanism that decelerates power from the transmission gear and transmits the power to the cleaning gear.

### Modification

In the above-described example embodiment, the cam gear tooth tip sliding surface 103 is provided, but the cam gear tooth tip sliding surface 103 may be replaced with a roller. Hereinafter, a modification in the case of replacement with a roller will be described.

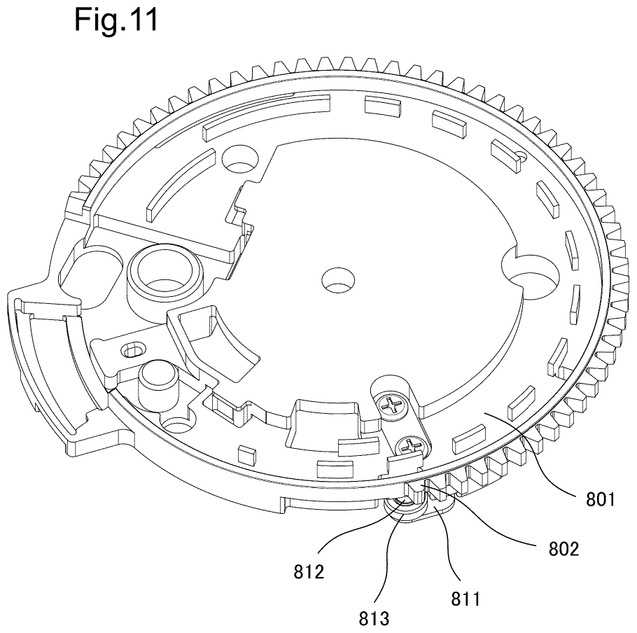

FIG. 11 is a detailed perspective view of a cam gear 801 in which the cam gear tooth tip sliding surface 103 is replaced with a roller 813. The roller 813 is provided at the end of the cam gear. The roller 813 is pivotally supported by a shaft 812 included in a roller holding arm 811, and is freely rotatable.

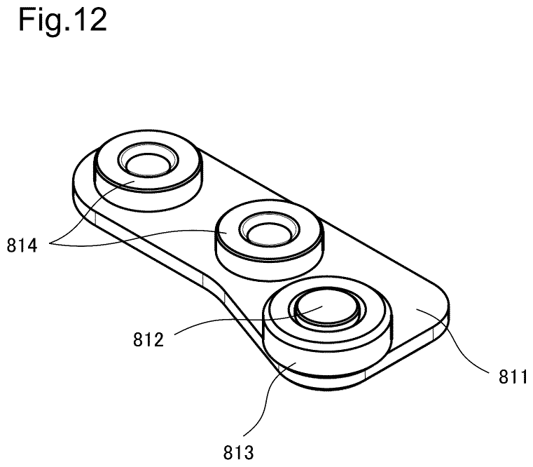

FIG. 12 is a perspective view of the roller holding arm 811 and the roller 813. The roller holding arm 811 includes a fixing shaft 814 provided with a screw hole separately from the shaft 812. The roller holding arm 811 is positioned such that the outer peripheral surface of the roller 813 is in contact with the surface of the cam gear terminal tooth 102 and the tooth tip portion. The roller holding arm 811 is screwed to the cam gear 801 via the fixing shaft 814. As a result, the roller 813 meshes with the transmission gear cylindrical surface starting tooth 213 like the cam gear terminal tooth 102, rides on the transmission gear cylindrical surface 212 so as to be in contact with the transmission gear cylindrical surface, and can roll on the transmission gear cylindrical surface 212. A tooth 802 at the preceding stage of the roller may be set to have a tooth tip length lower than that of a normal tooth. As a result, it is possible to absorb the deviation of the meshing of the teeth which may be caused by replacing the cam gear tooth tip sliding surface 103 with the roller 813.

When the cam gear tooth tip sliding surface 103 is replaced with the roller 813 in this manner, the following effects can be obtained. By replacing with the roller 813, it is possible to reduce a sliding load generated by sliding (friction) with the transmission gear cylindrical surface 212 and reduce member wear. As a result, the life of the entire magnetic head cleaning mechanism 10 can be further prolonged.

The present invention has been described above using the above-described example embodiments as exemplary examples. However, the present disclosure is not limited to the above-described example embodiments. That is, various aspects that can be understood by those of ordinary skill in the art can be applied to the present disclosure without departing from the spirit and scope of the present invention as defined by the claims.

This application is based upon and claims the benefit of priority from Japanese patent application No. 2023-042765, filed on Mar. 17, 2023, the disclosure of which is incorporated herein in its entirety by reference.

### REFERENCE SIGNS LIST

1 magnetic tape device
10 magnetic head cleaning mechanism
101 cam gear
102 cam gear terminal tooth
103 cam gear tooth tip sliding surface
104 first projection
105 second projection
106 first space
107 second space
108 third space
112 first torsion coil spring
113 second torsion coil spring
114 magnetic tape traction arm
115 magnetic tape holding member
116 cylindrical portion
121 cartridge reel
122 magnetic tape
123 leader pin
124 reel
151 guide roller group
161 magnetic head
171 sensor Flag
201 transmission gear
211 transmission large gear
212 transmission gear cylindrical surface
213 transmission gear cylindrical surface starting tooth
214 transmission gear protrusion
221 transmission small gear
501 tooth-missing gear
502 tooth-missing large gear
503 tooth-missing small gear
504 tooth-missing gear cylindrical surface
601 cleaning gear
602 cleaning gear starting tooth
611 anti-lock spring
701 cleaning large arm
702 abutment portion
710 cleaning arm
711 coupling portion
721 cleaning small arm
722 guide pin
731 cleaning member
741 holder
742 smooth surface
801 cam gear
802 tooth
811 roller holding arm
812 shaft
813 roller
814 fixing shaft

What is claimed is:

1. A magnetic head cleaning device comprising:
a transmission gear that is connected to a driving source;
a cam gear that is connected to mesh with the transmission gear;
a cutting structure that cuts power transmission of the cam gear and the transmission gear when a magnetic tape wound state is reached, the cutting structure including a transmission large gear provided on one side of the transmission gear and having a cylindrical surface in a partial range;
a tooth-missing gear that is connected to mesh with the transmission gear;
a cleaning gear that is connected to mesh with the tooth-missing gear;
a gear train that decelerates and transmits power from the transmission gear to the cleaning gear;
a cleaning arm that is connected to the cleaning gear and includes a cleaning member that cleans a magnetic head; and
an intermittent transmission structure that cuts power transmission of the tooth-missing gear and the cleaning gear until the magnetic tape wound state is reached and that starts the transmission in a case where the magnetic tape wound state is reached, the intermittent transmission structure including a tooth-missing small gear provided on one side of the tooth-missing gear and having a cylindrical surface in a partial range.

2. The magnetic head cleaning device according to claim 1, wherein
a number of teeth and meshing positions of the transmission gear and the cam gear are set in such a way that a terminal tooth of the cam gear and a starting tooth of a cylindrical surface of the transmission gear are engaged with each other in a magnetic tape wound state.

3. The magnetic head cleaning device according to claim 2, wherein a cylindrical surface of the transmission gear and a tooth tip portion of a terminal tooth of the cam gear have surface roughness suitable as a sliding surface.

4. The magnetic head cleaning device according to claim 1, wherein
the cleaning gear is partially provided with teeth, and
a generation range and a meshing position of teeth of the tooth-missing gear are set in such a way that teeth of the tooth-missing small gear start meshing with a starting tooth of the cleaning gear after the cam gear is stopped by the cutting structure.

5. The magnetic head cleaning device according to claim 4, wherein a cylindrical surface of the tooth-missing gear and a tooth tip portion of a starting tooth of the cleaning gear have surface roughness suitable as a sliding surface.

6. The magnetic head cleaning device according to claim 1, further comprising a sensor flag that is for detecting that a cleaning member provided at a tip of the cleaning arm reaches a magnetic head cleaning position,
wherein the driving source stops power transmission when reaching the magnetic head cleaning position is detected by the sensor flag.

7. The magnetic head cleaning device according to claim 1, comprising a roller at a terminal end of the cam gear,
wherein a number of teeth and meshing positions of the transmission gear and the cam gear are set in such a way that the roller and a starting tooth of a cylindrical surface of the transmission gear are engaged in a magnetic tape wound state.

8. The magnetic head cleaning device according to claim 7, wherein a tooth at a front stage of the roller has a tooth length smaller than a tooth length of other teeth of the cam gear.

9. A magnetic tape device comprising the magnetic head cleaning device according to claim 1.
